(19) United States
(12) Patent Application Publication
(10) Pub. No.: US 2019/0081536 A1
(43) Pub. Date: Mar. 14, 2019

(54) SYSTEM AND METHOD FOR GENERATING POWER FROM COMPRESSOR STATIONS

(71) Applicant: Terry W. Robinson, Irvine (CA)

(72) Inventor: Terry W. Robinson, Irvine (CA)

(21) Appl. No.: 15/700,646

(22) Filed: Sep. 11, 2017

(51) Int. Cl. H02K 7/18; F02B 63/04; H02P 9/06

(52) U.S. Cl. CPC H02K 7/1815; F02B 63/04; F16D 25/123; H02P 9/06; H02K 7/1823

(57) ABSTRACT

Described herein is a system and method for generating electricity that comprises using the excess horsepower capacity of engines at compressor sites to drive an electricity generator. The engine and generator are rotationally coupled and spaced from one another. A clutch is disposed between the engine and the generator. The clutch provides safety and control mechanisms to soft start the generator, and to disengage the engine from the generator when needed. A gear reducer to increase the rpm from the engine to an rpm that is sufficiently high to operate the generator may also be used. The system and method described herein provide an alternate means of producing usable power for the electric power grid that is cost effective and leaves a very small carbon footprint.

### FIELD

Described herein is a system, method and apparatus for running an electricity generator using the engines of compressor stations of natural gas pipelines.

### BACKGROUND

Natural gas is transported from supply areas to centers of consumption in large gas pipelines, frequently over distances of several thousand kilometres. These long-distance gas pipelines are operated at elevated pressures.

Unavoidably, there is a loss of pressure along the pipelines over long distances, because of friction between the gas and the pipeline wall. Therefore, in order to make the gas flow continuously, the gas must be re-pressurized at suitable locations along the pipeline. This is accomplished by compressor stations, also known as pumping stations, which are situated at intervals along the pipeline, typically about every 80 to 200 kilometres. These stations mechanically compress the natural gas to boost its pressure, commonly using turbines that are powered by gas taken from the pipeline.

Because pipelines transporting gas often are thousands of kilometres long, a number of compressor stations are needed. The location, size and number of compressor stations along a pipeline route is dependent on many factors, including the operating pressure of the pipeline, the diameter of the pipe, the volume of gas to be moved, the terrain, and the number of gas wells in the vicinity.

Compressors are designed to operate on a nonstop basis, that is, 24 hours a day 365 days a year; and most are unmanned and monitored offsite. They are conventionally driven by engines that have enough horsepower and throughput capacity to exceed requirements needed to pressurize the pipeline. Further, reflective of high initial gas reservoir pressures, pipelines are commonly initially operated at correspondingly high pressures requiring the engines to initially operate at a higher horsepower, but later as pressure in the reservoir and pipeline decreases, the engines will operate at a lower horsepower. Thus, over time compressor stations have unused available horsepower which is not needed for pipeline operations. To date, this available horsepower has not been recoverable, nor taken advantage of.

### SUMMARY

Disclosed herein is a method and system for generating electricity using excess horsepower that is available from an LPG or Diesel engine running at a pipeline compressor station. More particularly, the engine drives a compressor that pressurizes the pipeline, but in running the compressor the engine is operating at lower than its capacity, meaning that excess horsepower is available for other uses. In the method and system described herein, this excess, available horsepower is used to drive an electricity generator. The method and system include a drive assembly for rotationally coupling the generator and the commonly incompatible mechanical output of the engine.

Because the engine commonly operates at a lower rpm than that needed by the generator, the method and system, and more particularly the drive assembly, may comprise a means for increasing the rpm of the engine output to the speed needed by the generator to generate electricity. Other safety and control mechanisms are included in the system and method described herein, to ensure that the operation of the generator does not compromise the operation of the compressor.

Accordingly, in one aspect, described herein is a system for generating electricity comprising:
a) an engine of a compressor station;
b) an electricity generator;
c) a rotational coupling between the engine and the generator, said rotational coupling comprising:
   i) a means for disconnecting the rotational coupling between the engine and the generator, and
   ii) a soft start device to soft start the generator.

In embodiments of the system the rotational coupling further comprises a gear box having an input shaft that rotates at a first rpm and an output shaft that rotates at a second rpm that is higher than the first rpm. In embodiments the means for disconnecting the rotational coupling is a clutch.

In embodiments of the system the soft start device is a clutch. In embodiments the clutch is a fluid driven friction clutch.

In embodiments the gear box comprises a gear train having a gear ratio between about 0.44 and 0.72. In embodiments the generator is spaced at least 1 metre from the engine. In embodiments the generator is housed in a generator building, and on a foundation. In embodiments the foundation is a pile foundation.

In another aspect, described herein is a system for generating electricity comprising:
a) an engine of a compressor station in a compressor station building;
b) an electricity generator in a generator building and on a foundation, and wherein the generator building is spaced a distance from the compressor station building;
c) a rotational coupling between the engine and the generator, said rotational coupling comprising:
   i) a fluid driven friction clutch disposed in a gear box;
   ii) a drive shaft having a first end and a second end, the first end connected to a rotating shaft of the engine and the second end connected to the input shaft of the gear box; and
   iii) the output shaft of the gear box connected to a rotating shaft of the generator.

In embodiments the gear box further comprises an input shaft that rotates at a first rpm and an output shaft that rotates at a second rpm that is higher than the first rpm. In embodiments the foundation is a pile foundation. In embodiments the drive shaft is about 2.7 metres long.

In embodiments the system further comprises delivering the electricity to an electric power grid. In embodiments the system further comprises electronic controls to disconnect the rotational coupling between the engine and the generator.

In another aspect, described herein is a method for generating electricity comprising:
a) identifying a compressor station having an engine that has available horsepower to drive an electricity generator;
b) rotationally coupling the engine to the electricity generator;
c) using the available horsepower to drive the generator, by driving the rotation of a shaft in the generator with engine; and
d) generating electricity by rotation of the shaft in the generator.

In embodiments the magnitude of the available horsepower is greater than about 300 horsepower.

In embodiments the driving of the rotation of the shaft in the generator with the engine can be reversibly coupled and uncoupled. In embodiments the reversible coupling and uncoupling is done with a clutch. In embodiments the clutch provides a soft start for the generator.

In embodiments, in using the available horsepower a shaft of the engine rotates at a first rpm and the shaft of the generator rotates at a second rpm that is higher than the first rpm.

In embodiments the method further comprises disposing a gear train between the engine and the generator, said gear train causing the shaft of the generator to rotate at the second rpm.

In embodiments the method further comprises providing electronic controls to monitor the compressor to ensure that its rpm remains at or above a threshold value, and to disengage the generator from the engine if the rpm of the compressor drops below the threshold value for longer than a predetermined time period.

### BRIEF DESCRIPTION OF THE DRAWINGS

FIG. 1 is a schematic depicting an embodiment of the system described herein;

FIG. 2 is a side perspective view of an embodiment of the gear box used in the method and system disclosed herein;

FIG. 3 is a side view of the embodiment of FIG. 2;

FIG. 3A is a view taken along a part of a cross section along line A-A of FIG. 3;

FIG. 4 is an end view of the embodiment of FIG. 2;

FIG. 5A is a plan view of an embodiment of a flexible connection which attaches the drive shaft to the engine at one end and the gear reducer; and

FIG. 5B is a cross section along line A-A of FIG. 5A.

### DETAILED DESCRIPTION

Conventionally, natural gas pipelines operate at an initial pressure that drops over time as the pressure of the reservoir(s) with which they are associated decreases. The engines that run compressors at compressor sites of natural gas pipelines are, therefore, designed to initially operate at a high horsepower, but as pressure in the pipeline decreases over time, they operate at a fraction of the horsepower for which they are rated. Thus, many engines associated with compressor sites are operating well below their design limits and have the capacity to operate at higher horsepower. Some estimates are, that for established pipelines, at least about 300 horsepower, or between about 300 to 900 horsepower (20 to 40% of available horsepower), are available from each engine. The system and method described herein relate to the conversion of this horsepower into electricity that can be supplied to the electric power grid.

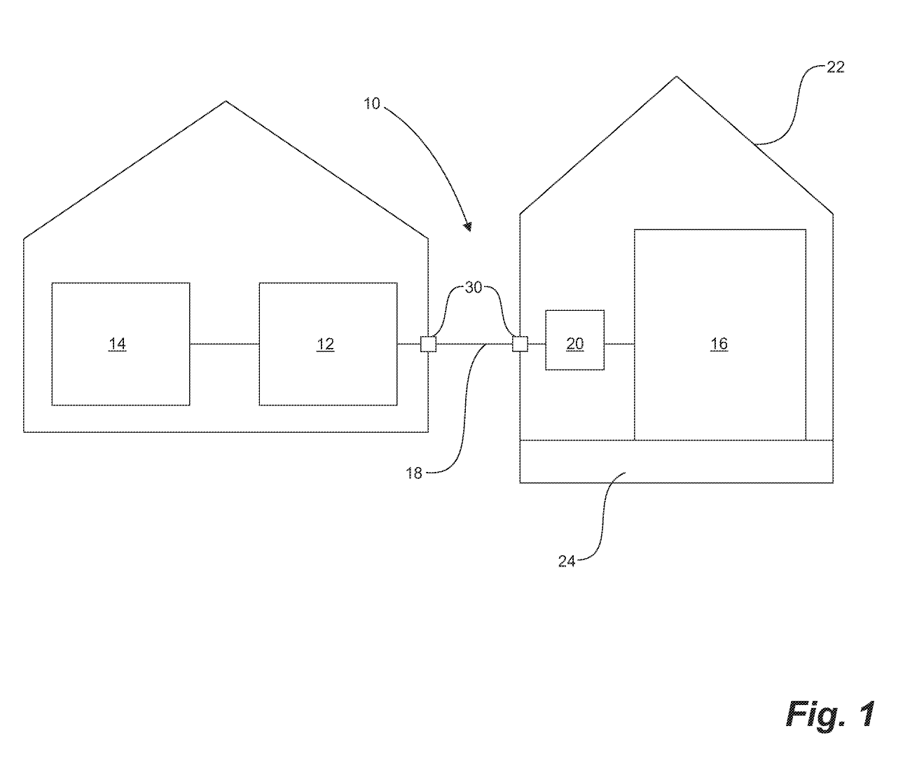

As shown in FIG. 1, the basic components of the system 10 are an engine 12 that is connected to a compressor 14 at one (a first) end, and which has the capacity to operate at a horsepower that is over and above that needed to drive the compressor 14 to pressurize the pipeline. This excess horsepower is sufficient to drive an electricity generator 16. The engine and compressor may be housed in an enclosure, such as a building, to protect them from the environment.

The engine 12 is rotationally coupled at its other (or second) end to an electricity generator 16 that is distanced from the engine 12. The engine and generator are rotationally coupled by a drive assembly which comprises a soft start device to soft start the generator, and a clutch for connecting and disconnecting the rotation of the generator by the engine. In one embodiment the drive assembly comprises a drive shaft 18 and a gear box 20 that houses the soft start device and the clutch. The rotation of the drive shaft 18 is driven by the engine 12. Because the rotation speed (rpm) of the engine, and therefore the drive shaft, is usually lower than the rpm required by the electricity generator to generate electricity, gear box 20 may further comprise a gear reducer that converts the lower rotation speed (rpm) of the drive shaft into a higher rpm required by the electricity generator. In some embodiments the soft start device and clutch are housed separately from the gear reducer. The electricity generator 16 and preferably also the gear box 20 are housed in a building 22 that comprises a foundation 24, preferably a pile foundation. In embodiments the gear box comprises a fluid drive friction clutch.

The cost of the extra fuel that is required by the engine to operate at a higher horsepower is more than compensated for by selling the electricity generated to the electric power grid. Moreover, engines being operated at a higher horsepower are operating closer to their design rating, improving efficiency and reducing carbon emission problems that result from running engines at lower loads.

In the method and system, an electric generator is driven by an LPG or diesel engine, using a rotating drive shaft that extends from one end of the engine to a gear reducer.

The gear reducer converts the rpm of the shaft into an rpm useable by the generator to generate electricity. The generator may be situated in an enclosure (the generator building 22) which functions to shield the generator from the environment. The generator building 22 is a separate structure that is distanced from the engine, because the heat generated by the engine as it operates continuously is significant, particularly in the summer season, and without cooling can be too high for operation of the generator close to the engine or within the same building as the engine and/or compressor. Further, electronics on the generator that monitor output power to the electric power grid are also adversely affected by higher temperatures. In preferred embodiments the generator is at least about 1 metre from the engine, more preferably more than about 3 metres, provided that the heat from the engine and compressor can be sufficiently dissipated so as not to adversely affect the operation of the generator or its controls.

Regulations commonly require that a distance of at least about 2.7 metres must be maintained between the building which houses the engine and compressor, and any other building. Accordingly, a in a preferred embodiment the distance between the engine and generator is at least about 2.7 metres.

The generator building 22 may further be insulated to keep the inside cool, which may be a concern particularly in the summer season in some locations.

The generator rests on a foundation 24, optionally on a skid that rests on the foundation 24. The generator may be enclosed in a building 22, and the top and sides of the building may be attached to the foundation or to the skid, for example by welding. The foundation 24 functions to transfer vibration loads from the generator to the surrounding soil or rock, without shifting or settling, thereby stabilizing the generator and ensuring that it remains properly aligned with the engine, as discussed further below.

Preferably foundation 24 is a pile foundation. A pile foundation is a deep foundation formed by long, slender, columnar elements typically made from steel or reinforced concrete and sometimes timber. The piles may be end-bearing piles, friction piles or a combination of both; they may be driven or screw piles prefabricated off site, bored piles that are poured in situ, or continuous flight augured (CFA) piles. The choice of pile will depend on the location and type of generator building, the ground conditions, durability of the materials and cost. Other types of foundations, such as shallow foundations are contemplated herein, provided that they provide the stability required.

As noted above, the distance between the engine 12 and the generator 16 is at least about 1 metre, and preferably greater. The drive shaft, which extends between one end of the engine and the gear box, should remain essentially horizontal over this distance, meaning that deviation from horizontal between the two ends of the drive shaft should be between about 1 to 3 degrees, and not less than about 1 degree. Thus, an important function of the foundation 22 is that it supports the generator and the gear box (see below) so that the drive shaft remains in this essentially horizontal position over time. The shaft is maintained in an essentially horizontal position to minimize wear on couplings, and deviation from horizontal should be at least 1 degree to facilitate proper lubrication and movement so that the drive assembly does not wear in one spot.

The drive shaft may be made of metal, such as steel or a steel alloy, or any other material, for example carbon fibre, that is suitable for the intended use of the drive shaft in accordance with this disclosure.

In preferred embodiments the distance between the engine and the generator is at least about 3 metres and may be much longer than that. In a particularly preferred embodiment the drive shaft, which extends between the engine and the gear box is about 2.7 metres long, or longer. While the system and apparatus described herein contemplate a distance between the engine and compressor of as little as 1 metre, in preferred embodiments this distance is longer. More particularly, it may be desirable to have a distance of at least 1 metre between the engine and the gear box (gear reducer) to facilitate the uncoupling of the drive assembly from the compressor engine, and another 0.5 metres between the gear box (gear reducer) and the generator to facilitate maintenance on both the gear reducer and the generator.

The generator 16 used in the systems and methods herein converts the rotational (mechanical) energy of the drive shaft extending from the engine, to electrical energy that is preferably delivered to the electric power grid, however it may be delivered optionally or in addition to a battery where it is stored for future use, or it may be used to provide power to an isolated site. The type of generator used will be determined by the requirements of the electric power grid to which the generator will be connected, provided that it converts rotational (mechanical) energy into electricity.

The generator may be selected to provide an electrical output at a fixed frequency of about 60 Hz to match the output of a standard electric power grid in North America, or at about 50 Hz for Europe. Generators commonly operate at 1800 rpm, however they can be designed to operate at other rpms, and these other generators are intended to be included herein.

Engines 12 that run compressors at compressor stations generally rotate at a revolution per minute (rpm) which is lower than the rpm required by a power generator to generate electricity. Thus, for example, many engines rotate at about 1100 or 1150 rpm, lower than the about 1800 rpm required for a standard power generator to operate. Accordingly, contemplated herein in some embodiments of the drive assembly is a gear reducer that converts the speed (rpm) of the rotating drive shaft at the input side of the gear box to an increased speed (rpm) at the output side of the gear box, as required by the generator.

In preferred embodiments gear reducer is housed in gear box 20. Gear box 20 may therefore comprise a gear train in a casing, which gear train functions to increase the rate of rotation of the output (driven) shaft over that of the input shaft (driver) shaft. The “gear ratio”, as defined herein is the ratio of the input speed (driver) relative to the output speed (driven): wᵢₙ:Wₒᵤₜ. As the speed (rpm) of the shaft at the input of the gear box is less than the speed (rpm) of the shaft extending from the output of the gear box, the gear ratio of the gear box 20 contemplated herein is less than 1.

The gear train can be any type of gear train, for example a simple gear train, a compound (including variable) gear train, a reverted gear train or a planetary (epicyclic) gear train, as are known in the art. The arrangement of the gear train depends upon the speed increase desired, the orientation of the input and the output shafts, and the size of the gear box. In some embodiments, a 90 degree speed increaser, for example a device similar to R. J. Link International's right angle speed increaser 1:1.57 may be used. While the gear box has at least one gear train that provides at least one gear ratio that is less than 1, embodiments contemplate a variable gear train that provides a plurality of different gear ratios that are less than one, and the desired gear ratio can then be selected depending on the rpm of the specific engine and/or the rpm of the specific generator to be used.

A preferred gear ratio range for the gear train described herein is between about 0.44 and 0.72, used when the rpm of the engine is between 800 and 1300 rpm and the rpm required for the generator is about 1800 rpm. A particularly preferred embodiment has a gear ratio of between 0.61 and 0.64, used when the rpm of the engine is between 1100 and 1150 rpm and the rpm for the generator is about 1800.

In embodiments the engine 12 and generator 16 rotate at essentially the same rpm and it is not necessary for the rpm to be increased between the engine and generator. These embodiments therefore do not include a gear reducer in the drive assembly.

Gear box 20 is operated by at least one clutch which connects (engages) and disconnects (disengages) the input and output shafts of the gear box; thus connecting and disconnecting the rotation of the engine from the rotation of the generator. Electronic controls may be used to engage and disengage the clutch. The use of a clutch enables an operator to disconnect the generator when not needed (for example, to turn it off when the grid does not need electrical power) without needing to turn off the engine. Further, the ability to disconnect the engine from the generator ensures that if operation of the generator were to somehow compromise the operation of the engine, the generator can be disconnected to allow for continued operation of the engine and consequently the compressor, to maintain pressure in the pipeline.

The gear box 20 can comprise any of a number of different types of clutches, and may have one or more clutches. The clutches may be manual or automatic; wet or dry; dog, friction or hydraulic; single plate, multi plate, cone or diaphragm; fluid; spring, centrifugal, electromagnetic, for example. Preferred for use herein is a fluid driven friction clutch.

Engines at compression stations operate continuously, and at only one speed, thus it is not practical to bring the generator up to speed by gradually increasing the rpm of the engine. Therefore, preferred embodiments of the system and method described herein include a soft start device that provides for a smooth, controlled acceleration of the generator to its steady state rpm; this in turn gradually increases the load and torque on the engine and reduces mechanical stresses on the engine and generator. The soft start avoids damage to the engine or compressor, or stalling of the engine, which might otherwise occur were the generator to immediately go from zero rpm to full operating speed.

The soft start can consist of a mechanical or electrical device, or a combination of both; however mechanical soft start devices are preferred. Mechanical soft starter devices include clutches and several types of couplings using a fluid, magnetic forces, or steel shot to transmit torque, similar to other forms of torque limiter. Electrical soft starters can be any control system that reduces the torque by temporarily reducing the voltage or current input.

Preferred in embodiments herein is a mechanical soft start device, as the system and method described herein are commonly used in remote locations where electronic controls and drives are difficult to power, program, and maintain. Mechanical soft starters are well known in the art and are manufactured and sold, for example by Dodge® or Twin Disk®.

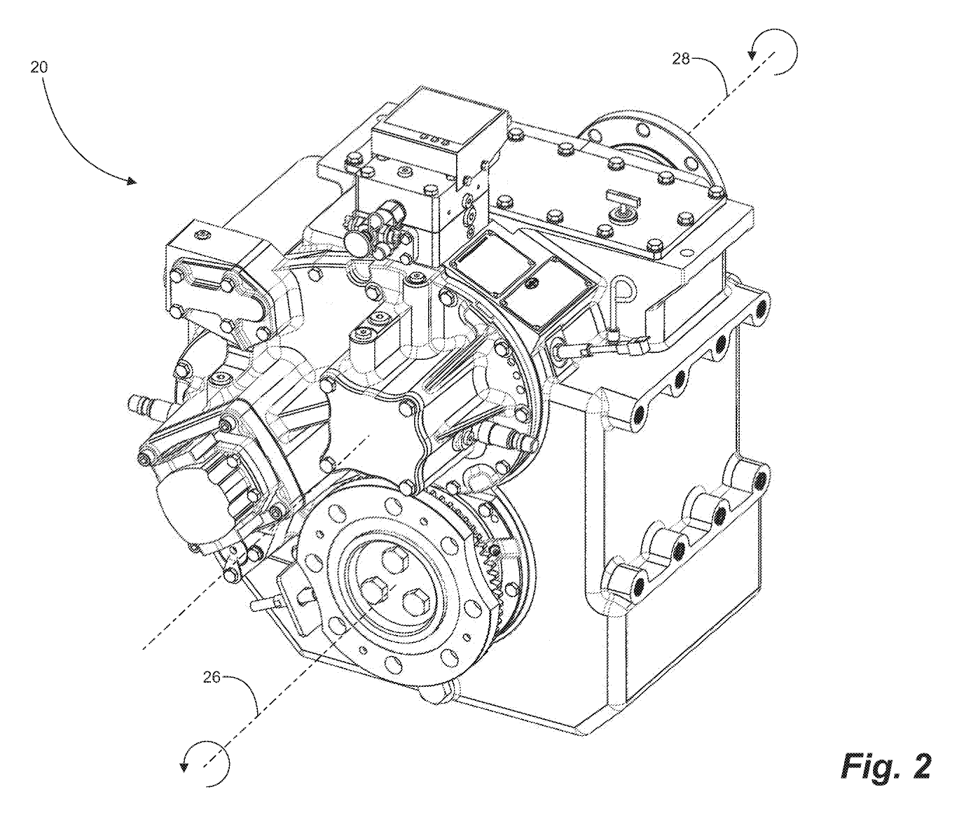

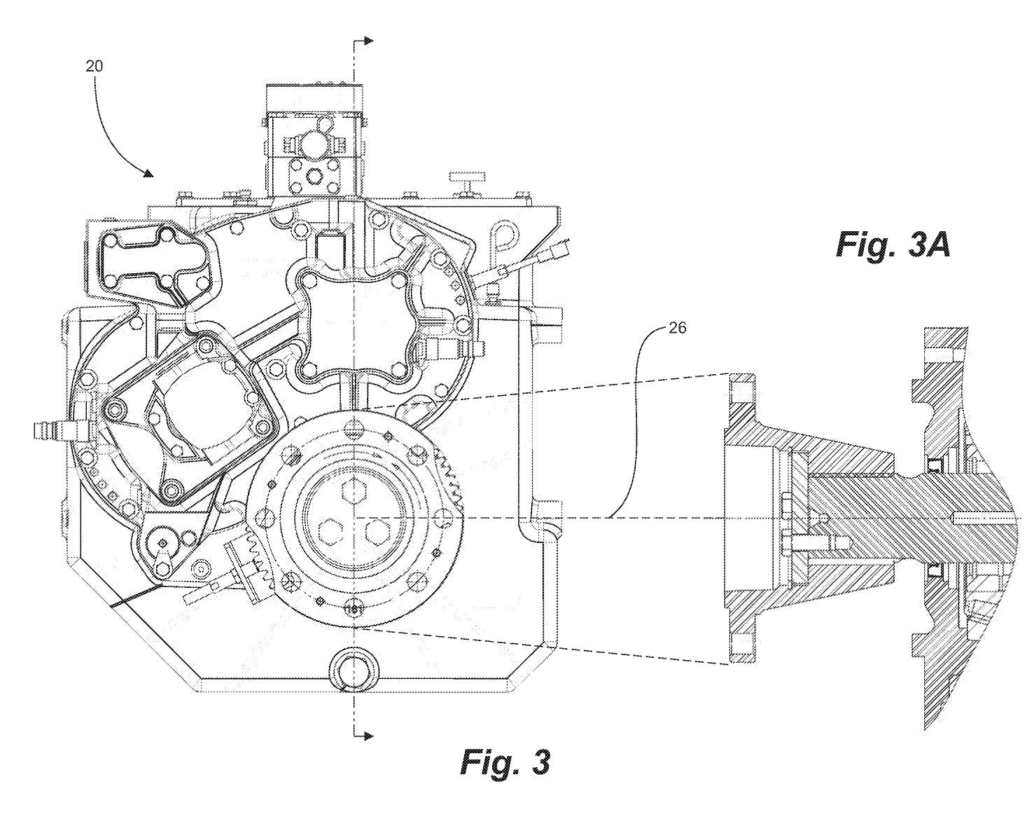

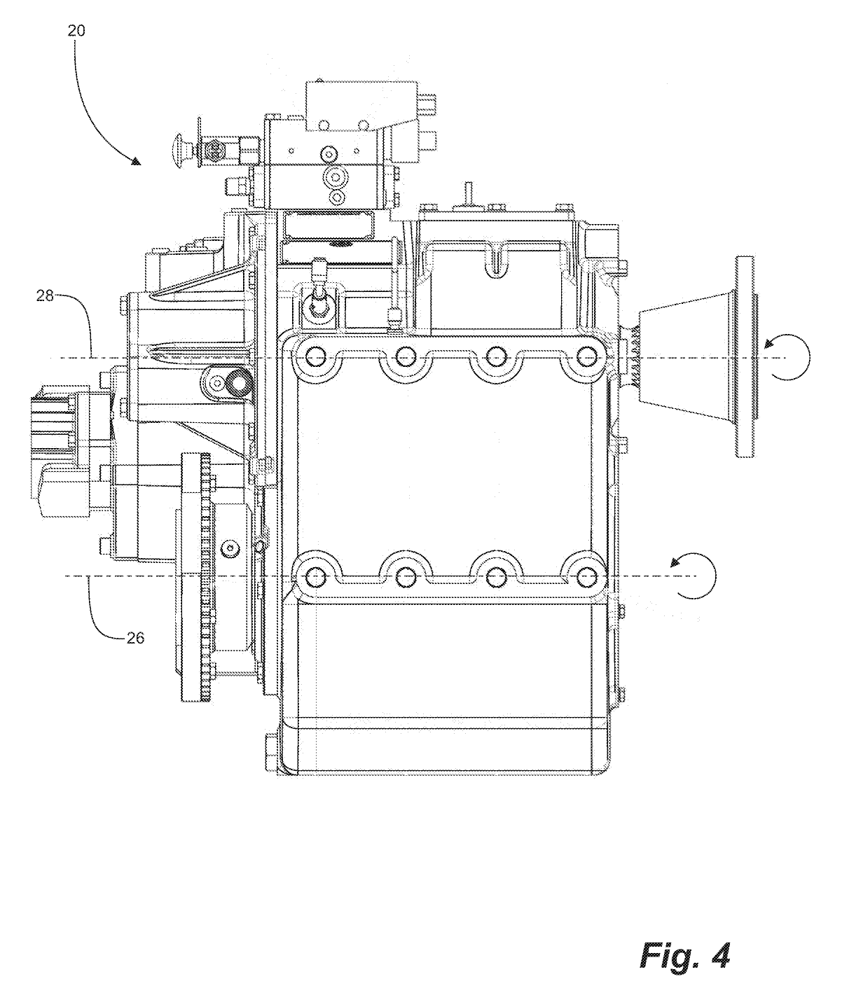

Of mechanical soft start devices, preferred is a fluid driven friction clutch, which connects and disconnects the input and output shafts of the gear box and which also provides a soft start, bringing the generator up to the required rpm within a specified period of time, and locking after the required rpm is attained. Clutch engagement does not occur instantaneously but takes place over time due to a gradual pressure increase in the actuating chamber. Such clutches have been described, for example, in U.S. Pat. No. 5,651,288, which is incorporated herein by reference in its entirety. An embodiment of the clutch is shown in FIGS. 2 to 4.

Another type of mechanical clutch is a clutch having a fluid coupling, which generally consists of a housing which contains hydraulic fluid and two bladed rotors with radial vanes, one an impellor connected to the input shaft and the other a runner connected to the output shaft. The input shaft rotates the impellor, which in turn accelerates the hydraulic fluid; this fluid with increased kinetic energy impinges on the runner, which reacts as a turbine rotating the output shaft. The hydraulic fluid may be motor oil. A clutch with a fluid coupling has lower efficiency than a fluid driven friction clutch, and there is a greater risk of oil spills and leaks when using these types of hydraulic systems. The amount of oil to operate a fluid driven friction clutch according to an embodiment described herein is less <20 L.

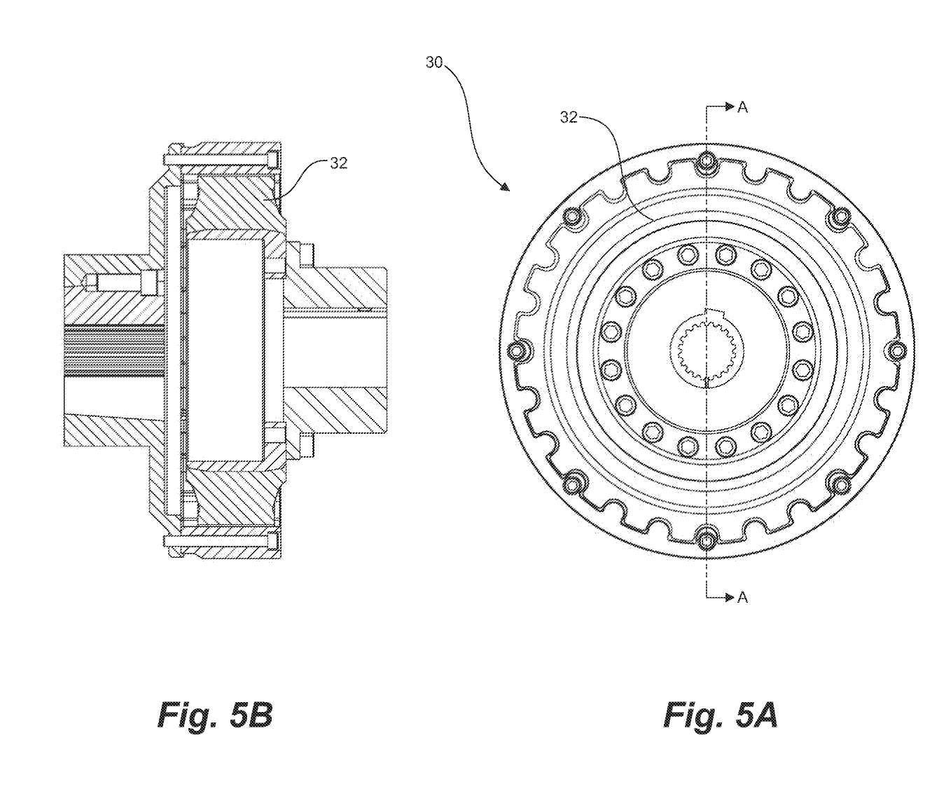

In embodiments, the system is configured to reduce torsional vibration along the drive shaft, which can harm the engine. Accordingly, flexible or antivibration mountings which absorb the vibration, such as rubber mounted couplings, may be used where the drive shaft exits the building around the engine, and where the drive shaft enters the generator building. Further, the drive shaft may be mounted to the housing of the gear box and to the engine via rubber mountings. An embodiment of the antivibration coupling that may be used at the gear box and the engine is shown in FIGS. 5 A and B.

Embodiments may also include a means to mechanically disconnect the drive shaft from the engine and/or generator, to eliminate any possibility of an accidental start while working on any component of the system—e.g., the engine, the drive or the generator. This disconnection means may be a slip joint on the drive assembly which enables the drive assembly to be uncoupled mechanically.

In embodiments the operation of the gear box (drive) is remotely monitored and controlled by a SCADA system (Supervisory Control and Data Acquisition), providing operators for the electric power grid with the capability of connecting the generator to the electric power grid to acquire the electricity generated, as well as to disconnect the generator when power is not required.

Embodiments include and under- and over-frequency relays for the generator. The under-frequency relay may ensure that the generator is brought up to speed before engaging the electric power grid, for otherwise the power generated will be under frequency and under voltage. Electronic controls may initiate the generator when its output is appropriate for connection to the electric power grid.

The electrical output of the generator may be maintained at a fixed frequency of about 60 Hz to match the output of a standard electric power grid in North America, or at about 50 Hz in Europe. Accordingly, the system and method may include under- and over-frequency controls to maintain the frequency within a desired range, shutting the generator down (i.e., disengaging the clutch) if the frequency is outside of that range. For use in North

America the system may include controls for maintaining the frequency between about 59.6 and 60.1 Hz, shutting down if frequency is below about 59.4 Hz or above about 61 Hz. The generator may include a number of relays that control the electrical output including: fault, phase imbalance and ground faults.

Further embodiments include controls to ensure that the operation of the generator does not compromise operation of the compressor. Therefore, electronic controls are provided so that if there is a possibility that the generator will compromise the operation of the compressor, it is disconnected from the engine. For example, engines of conventional compressor stations run constantly and at a constant rpm. If the rpm decreases, conventional electronic controls will stop the engine if rpm is not back up to the required rpm within a specified time, for example, 30 seconds. In the system and method described herein, when the generator is started up, any consequent reduction in the rpm of the engine must be remedied before the 30 seconds has passed, to avoid shut down of the engine. Controls are therefore provided to shut the generator off (i.e., disconnect the clutch) before this might happen.

### Method

In the method, an engine is selected to run at a specific first rpm, and when the engine is coupled at one end to a compressor, the compressor will maintain the pipeline at a specified pressure. The rpm of the engine and the pipeline pressure are monitored and controlled, as known in the art.

At the first rpm, the engine is operating below capacity, that is, below its maximum horsepower rating. Thus, the engine has excess capacity and has enough available horsepower to drive an electricity generator, when operating at the first rpm.

An electricity generator which is capable of generating electricity at a second rpm that may be higher than the first rpm, is selected. The generator is housed in a building and on a stable foundation, and is distanced from engine because heat from the engine and/or compressor may compromise the operation of the generator or its controls.

The engine and the generator are releasably and rotationally coupled, so that the rotation of a shaft within the engine at the first rpm drives the rotation of a shaft within the generator at the second rpm. The rotational coupling may include a means for converting the first rpm of the shaft within the engine to the second higher rpm of the shaft of the generator. In an embodiment, rotational coupling is accomplished by a combination of a drive shaft and a gear box; the engine rotates the drive shaft at the first rpm, the gear box increases the rpm to the second rpm required by the generator, and then causes the shaft of the generator to rotate at the second rpm.

In preferred embodiments the rotational coupling includes means to soft start the generator, so that the ramp up to operating speed is gradual, avoiding damage to the generator or engine, or avoiding stalling the engine.

In preferred embodiments the gear box includes a reversible connection means, such as a clutch, so that the engine and the compressor can be rotationally connected and disconnected as needed. An ability to disconnect may be needed, for example, if an operator desires to turn off or generator for maintenance or because the power is not needed for the grid, or if the operation of the generator compromises, or is at a risk of compromising, the ability of the engine to operate the compressor.

Having thus described the basic system and method herein, a specific embodiment will now be described, as shown in the accompanying Figures.

FIGS. 2 to 4 are drawings of an embodiment of the gear box used in the method and systems herein. The gear box is a modified TwinDisc® transmission used in marine applications, that has fluid flow and gearing optimized for use in the systems and methods herein. More particularly, in this embodiment the gear box comprises a fluid drive friction clutch and has a gear train that converts an input rpm of 1150 from the engine to an output rpm of 1800 for running the generator. The clutch is a wet clutch, and comprises stacking multiple clutch discs immersed in a lubricating fluid (motor oil).

In the embodiment shown in FIGS. 2 to 4, the axis of rotation of the output shaft is shown by dashed line 26, and the axis of rotation of the input shaft is shown by dashed line 28.

In an embodiment, the drive shaft is 2.7 metres long, having a diameter of about 3″, and is made of tubular steel.

Embodiments of engines for use herein are Gas compression engines Cat G3516™ and the Wakesha L7044GSI™. These are typically 1400 and 1600 horsepower engines that run on natural gas.

Embodiments of the generators contemplated are the synchronous type, continuous duty, dual bearing (for longer maintenance times) generators rated at 385 kVA, 425 kVA or 700 kVA, having a moment of inertia of 4.02/4.04 kg-m², 5.19/5.20 kg-m², and 10.47 k-gm², respectively. The clutch was designed taking into account the torque required to start the generator, the engine speed and the available horsepower from the engine.

FIGS. 5A and 5B are drawings of an embodiment of a coupling 30 that may be used to couple the drive shaft to a rotating shaft of the engine or to the input shaft of the gear box, or to couple the output shaft of the gear box to the rotating shaft of the generator. The coupling comprises a splined rubber insert 32 (e.g., as made by Lovejoy® or Reich®) as an antivibration material, and tapered bushings with splines.

While the system and method have been described in conjunction with the disclosed embodiments which are set forth in detail, it should be understood that this is by illustration only and the method and system are not intended to be limited to these embodiments. On the contrary, this disclosure is intended to cover alternatives, modifications, and equivalents which will become apparent to those skilled in the art in view of this disclosure.

1. A system for generating electricity comprising:
a) an engine of a compressor station;
b) an electricity generator;
c) a rotational coupling between the engine and the generator, said rotational coupling comprising:
i) a means for disconnecting the rotational coupling between the engine and the generator; and
ii) a soft start device to soft start the generator.

2. The system of claim 1 wherein the rotational coupling further comprises a gear box having an input shaft that rotates at a first rpm and an output shaft that rotates at a second rpm that is higher than the first rpm.

3. The system of claim 1 wherein the means for disconnecting the rotational coupling is a clutch.

4. The system of claim 1 wherein the soft start device is a clutch.

5. The system of claim 3 wherein the clutch is a fluid driven friction clutch.

6. The system of claim 1 wherein the gear box comprises a gear train having a gear ratio between about 0.44 and 0.72.

7. The system of any one of claim 1 wherein the generator is spaced at least 1 metre from the engine.

8. The system of claim 1 wherein the generator is housed in a generator building, and on a foundation.

9. The system of claim 8 wherein the foundation is a pile foundation.

10. A system for generating electricity comprising:
a) an engine of a compressor station in a compressor station building;
b) an electricity generator in a generator building and on a foundation, and wherein the generator building is spaced a distance from the compressor station building;
c) a rotational coupling between the engine and the generator, said rotational coupling comprising:
i) a fluid driven friction clutch disposed in a gear box;
ii) a drive shaft having a first end and a second end, the first end connected to a rotating shaft of the engine and the second end connected to the input shaft of the gear box; and
iii) the output shaft of the gear box connected to a rotating shaft of the generator.

11. The system of claim 10 wherein the gear box further comprises an input shaft that rotates at a first rpm and an output shaft that rotates at a second rpm that is higher than the first rpm

12. The system of claim 10 wherein the foundation is a pile foundation.

13. The system of claim 10 wherein the drive shaft is about 2.7 metres long.

14. The system of claim 1 further comprising delivering the electricity to an electric power grid.

15. The system of claim 1 further comprising electronic controls to disconnect the rotational coupling between the engine and the generator.

16. A method for generating electricity comprising:
a) identifying a compressor station having an engine that has available horsepower to drive an electricity generator;
b) rotationally coupling the engine to the electricity generator;
c) using the available horsepower to drive the generator, by driving the rotation of a shaft in the generator with the engine;
d) generating electricity by rotation of the shaft in the generator.

17. The method of claim 16 wherein the magnitude of the available horsepower is greater than about 300 horsepower.

18. The method of claim 16 wherein the driving of the rotation of the shaft in the generator with the engine can be reversibly coupled and uncoupled.

19. The method of claim 18 wherein the reversible coupling and uncoupling is done with a clutch.

20. The method of claim 19 wherein the clutch provides a soft start for the generator.

21. The method claim 16 wherein, in using the available horsepower a shaft of the engine rotates at a first rpm and the shaft of the generator rotates at a second rpm that is higher than the first rpm.
